(19) United States
(12) Patent Application Publication
(10) Pub. No.: US 2004/0121048 A1
(43) Pub. Date: Jun. 24, 2004

(54) Food product system

(76) Inventor: Len C. Kretchman, Fergus Falls, MN (US)

Correspondence Address: Michael S. Neustel, Suite No. 4, 2534 South University Drive, Fargo, ND, 58103, US

(21) Appl. No.: 10/327,153

(22) Filed: Dec. 20, 2002

(51) Int. Cl. A23B 4/00

(52) U.S. Cl. 426/112

(57) ABSTRACT

A food product system for efficiently manufacturing, storing and mixing a chocolate and peanut butter coated biscuit. The food product system includes a container, a layer of sweetener is positioned within the inner lower portion of the container, and a plurality of cereal members coated with an outer coating positioned upon the sweetener within the container. In use, the consumer grasps the container and manipulates the container in a shaking manner thereby thoroughly mixing the sweetener upon the cereal members wherein the sweetener is secured to the outer coating. The sweetener is preferably powdered sugar or a similar material. The outer coating is preferably comprised of a chocolate or similar material.

### CROSS REFERENCE TO RELATED APPLICATIONS

Not applicable to this application.

### STATEMENT REGARDING FEDERALLY

### SPONSORED RESEARCH OR DEVELOPMENT

Not applicable to this application.

### BACKGROUND OF THE INVENTION

1. Field of the Invention

The present invention relates generally to snack food products and more specifically it relates to a food product system for efficiently manufacturing, storing and mixing a chocolate and peanut butter coated biscuit.

2. Description of the Related Art

Chocolate and peanut butter coated biscuits have been made in homes for years and are often times referred to as “puppy chow”. Chocolate and peanut butter coated biscuits are typically comprised of a mixture of melted chocolate chips and peanut butter combined to coat a volume of cereal biscuits. The cereal utilized is preferably a grain based cereal such as corn, wheat, or rice commercially available today under the brand names CRISPIX manufactured by KELLOGG COMPANY and CHEX manufactured by GENERAL MILLS. After the cereal is fully coated with the chocolate mixture, a volume of powered sugar is mixed with the coated cereal to create the snack product. Often times butter and sometimes vanilla flavoring are mixed into the recipe.

The problem with conventional methods of making chocolate and peanut butter coated biscuits is that the resulting product does not have an extended shelf life for commercial sales and must be made within the home. Over extended periods of time exceeding one day, the snack begins to discolor caused by the powdered sugar absorbing the oils from the peanut butter and chocolate mixture. Another problem with conventional chocolate and peanut butter coated biscuits is that it is difficult to consume in remote locations since the product is not suitable for storage for extended periods of time.

While these devices may be suitable for the particular purpose to which they address, they are not as suitable for efficiently manufacturing, storing and mixing a chocolate and peanut butter coated biscuit. Conventional chocolate and peanut butter coated biscuits recipes are not suitable for commercial production and the resulting product is not aesthetically agreeable after sitting for extended periods of time.

In these respects, the food product system according to the present invention substantially departs from the conventional concepts and designs of the prior art, and in so doing provides an apparatus primarily developed for the purpose of efficiently manufacturing, storing and mixing a chocolate and peanut butter coated biscuit.

### BRIEF SUMMARY OF THE INVENTION

In view of the foregoing disadvantages inherent in the known types of snack food products now present in the prior art, the present invention provides a new food product system construction wherein the same can be utilized for efficiently manufacturing, storing and mixing a chocolate and peanut butter coated biscuit.

The general purpose of the present invention, which will be described subsequently in greater detail, is to provide a new food product system that has many of the advantages of the snack food products mentioned heretofore and many novel features that result in a new food product system which is not anticipated, rendered obvious, suggested, or even implied by any of the prior art snack food products, either alone or in any combination thereof.

To attain this, the present invention generally comprises a container, a layer of sweetener is positioned within the inner lower portion of the container, and a plurality of cereal members coated with an outer coating positioned upon the sweetener within the container. In use, the consumer grasps the container and manipulates the container in a shaking manner thereby thoroughly mixing the sweetener upon the cereal members wherein the sweetener is secured to the outer coating. The sweetener is preferably powdered sugar or a similar material. The outer coating is preferably comprised of a chocolate or similar material.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a food product system that will overcome the shortcomings of the prior art devices.

A second object is to provide a food product system for efficiently manufacturing, storing and mixing a chocolate and peanut butter coated biscuit.

Another object is to provide a food product system that provides a snack food product based upon cereal, chocolate, peanut butter and powdered sugar that has an extended shelf-life.

An additional object is to provide a food product system that provides entertainment value to the end consumer.

A further object is to provide a food product system that provides a fresh and pleasant appearing final product to the consumer.

Another object is to provide a food product system that has a shelf life of greater than two weeks.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention in a storage position.

FIG. 2 is a side view of the present invention being shaken.

FIG. 3 is a side view of the present invention after being shaken.

FIG. 4 is a cross sectional view taken along line 4-4 of FIG. 1.

FIG. 5 is a cross sectional view taken along line 5-5 of FIG. 3.

FIG. 6 is a cutaway view of a cereal member coated with chocolate layer and a powdered sugar.

FIG. 7 is a flowchart illustrating the manufacture of the present invention.

FIG. 8 is a flowchart illustrating the manipulation of the present invention to create the chocolate and peanut butter coated biscuit.

### DETAILED DESCRIPTION OF THE INVENTION

A. Overview

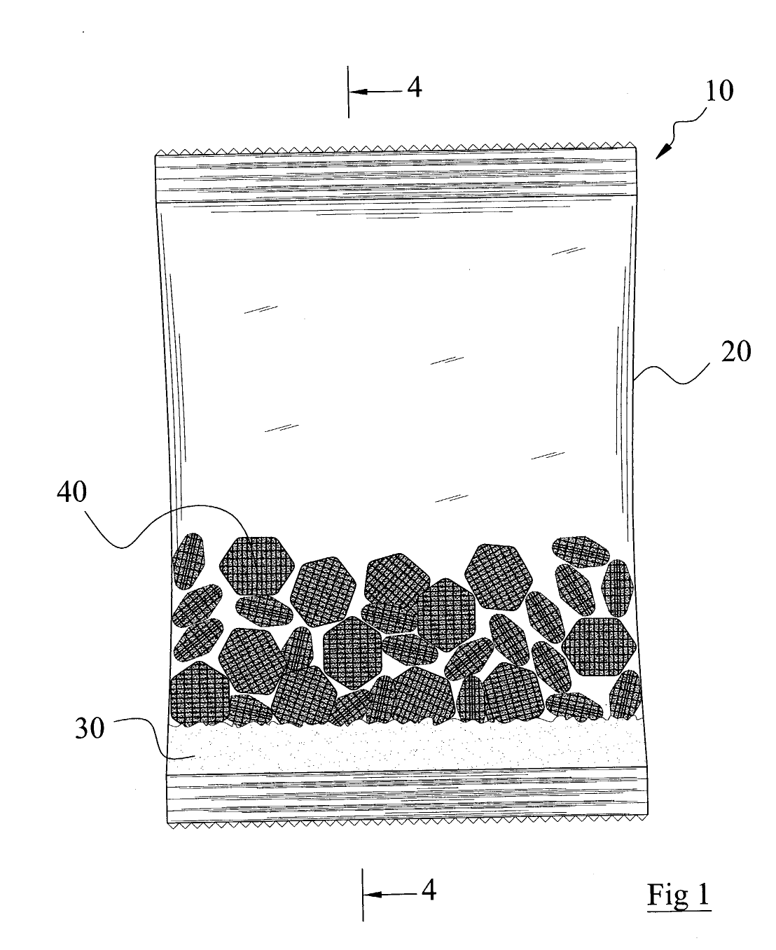

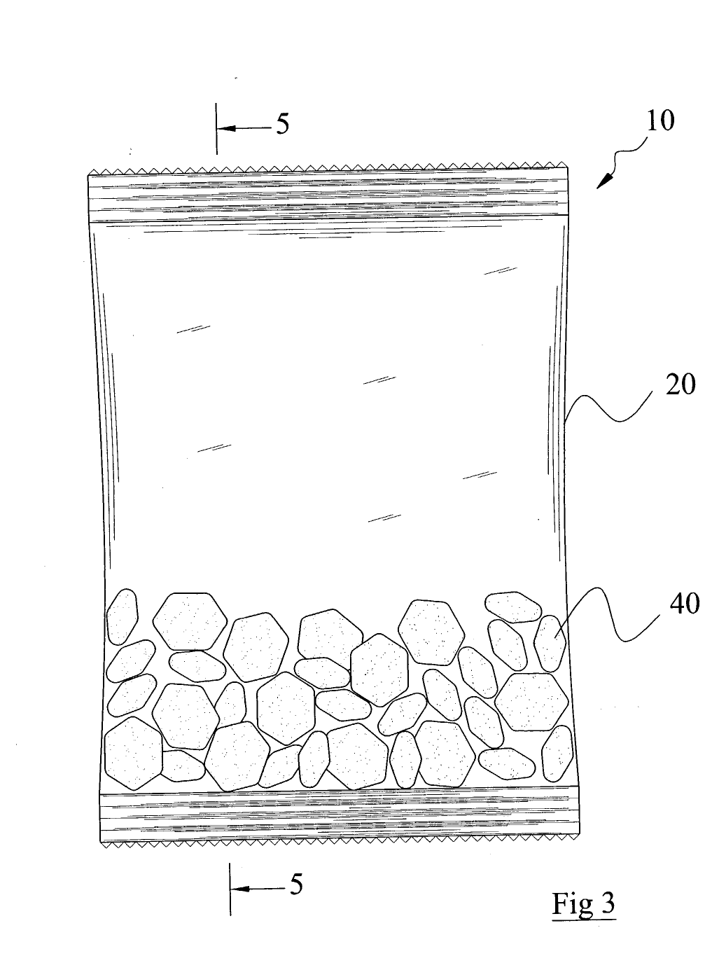

Turning now descriptively to the drawings, in which similar reference characters denote similar elements throughout the several views, FIGS. 1 through 8 illustrate a food product system 10, which comprises a container 20, a layer of sweetener 30 is positioned within the inner lower portion of the container 20, and a plurality of cereal members 40 coated with an outer coating 42 positioned upon the sweetener 30 within the container 20. In use, the consumer grasps the container 20 and manipulates the container 20 in a shaking manner thereby thoroughly mixing the sweetener 30 upon the cereal members 40 wherein the sweetener 30 is secured to the outer coating 42. The sweetener 30 is preferably powdered sugar or a similar material. The outer coating 42 is preferably comprised of a chocolate or similar material.

B. Container

FIGS. 1 through 5 illustrate an exemplary container 20 for usage within the present invention. The container 20 is preferably transparent or semi-transparent for allowing viewing of the interior contents. However, the container 20 may be comprised of an opaque material. The container 20 may have combinations of transparent, semi-transparent, colored and opaque materials for providing various viewing effects.

The container 20 preferably has a sufficient interior volume for storing the cereal members 40 and sweetener 30 along with sufficient room for thoroughly mixing the same within the container 20 by movements. The container 20 may have various shapes and structures other than illustrated in FIGS. 1 through 5 of the drawings.

The container 20 is preferably comprised of a flexible plastic bag structure for allowing manipulation of the contents within the container 20 as shown in FIGS. 1 through 5 of the drawings. A paper bag or similar structure may be utilized instead of a flexible plastic bag. In addition, the container 20 may be comprised of a structure comprised of a rigid material such as but not limited to plastic, cardboard, composite and the like. The drawings should not limit the various structures that may be utilized for the container 20.

C. Cereal Members

As shown in FIGS. 1 through 5 of the drawings, a plurality of cereal members 40 are provided within the interior of the container 20 upon the upper part of the sweetener 30. The cereal members 40 are preferably comprised of a grain based cereal such as but not limited to rice, corn or wheat. The cereal members 40 further preferably have a ribbed polygonal structure having a hollow interior as best illustrated in FIGS. 1, 4 and 5 of the drawings. It can be appreciated that the cereal members 40 may be comprised of various other materials and structures other than discussed above or illustrated in the drawings.

D. Outer Coating

The cereal members 40 are preferably coated with an outer coating 42. The outer coating 42 is preferably comprised of a chocolate based material that is heated into a melted liquid state and then applied to the cereal members 40 forming a hardened layer. The outer coating 42 may penetrate into the interior portions of the cereal members 40 which is well-known in the art.

The outer coating 42 is preferably comprised of a mixture of chocolate and peanut butter or other substances. Conventional butter or butter substitutes may be added to the outer coating 42 before applying to the cereal member 40. In addition, flavorings such as but not limited vanilla may be added to the outer coating 42 for providing various flavorings. The outer coating 42 may be comprised of various other materials and flavorings not discussed.

E. Sweetener

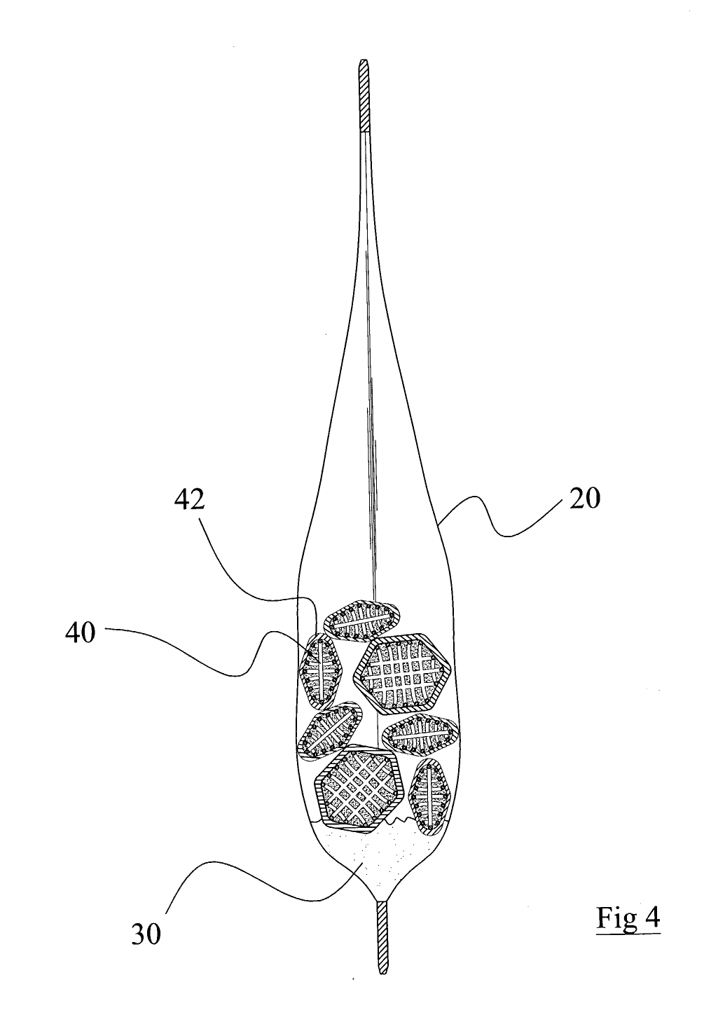

A volume of sweetener 30 is positioned within the lower portion of the container 20 as illustrated in FIGS. 1 and 4 of the drawings. The volume of sweetener 30 positioned within the container 20 is preferably sufficient to thoroughly coat the coated cereal members 40.

The sweetener 30 is preferably comprised of powdered sugar or similar material. The sweetener 30 may be comprised of various other materials such as granular sugar, artificial sugar, brown sugar and the like.

F. Commercial Manufacturing

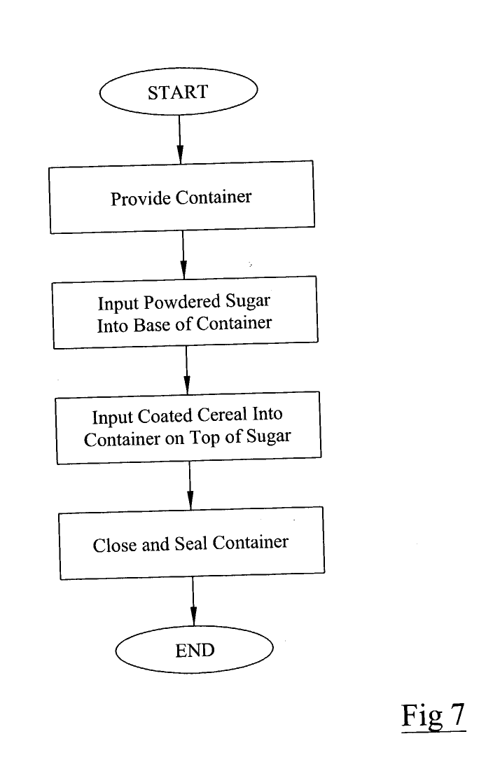

FIG. 7 illustrates the overall process of manufacturing the present invention. It can be appreciated that this manufacturing process may be accomplished utilizing manual labor techniques or high-speed commercial equipment. For the purposes of discussion only, we will discuss the manufacture of a single unit of the present invention.

The first step in the manufacturing process is to provide the desired container 20 with a loading opening. The second step is to then input a volume of sweetener 30 into the lower portion of the container 20 as further stated in FIG. 7 of the drawings.

Pre-coated cereal members 40 coated with the outer coating 42 are then input into the container 20 directly on top of the sweetener 30 as shown in FIGS. 1 and 4 of the drawings. It can be appreciated that a removable divider may be positioned between the sweetener 30 and the cereal members 40 to prevent and reducing mixing of the contents of the container 20.

After the cereal members 40 have been properly positioned within the container 20, the user then seals the container 20 preferably with a volume of air within the container 20 to allow for shaking and manipulating of the container 20 for mixing purposes by the end consumer.

After the container 20 is sealed, the container 20 may be positioned within a larger storage unit with other containers for transporting to a regional distribution center or directly to a store for sale. During transportation, some of the sweetener 30 may engage and stick to portions of the cereal members 40, however a majority of the sweetener 30 is retained within a lower level of the container 20 having a higher density than the cereal members 40.

G. Consumer Usage

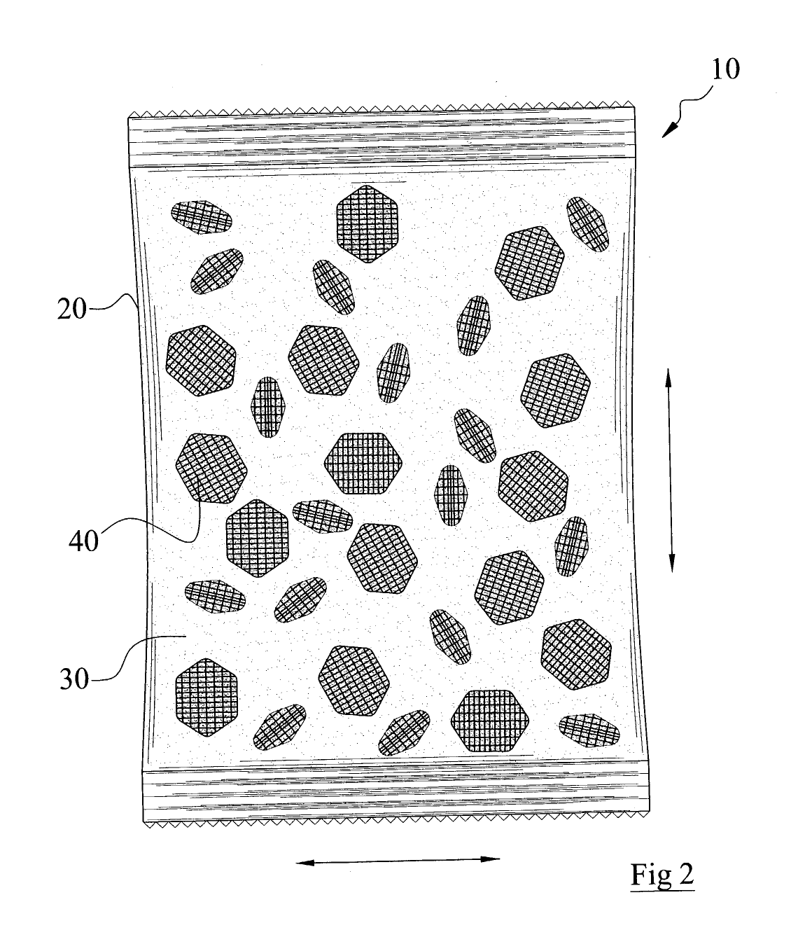

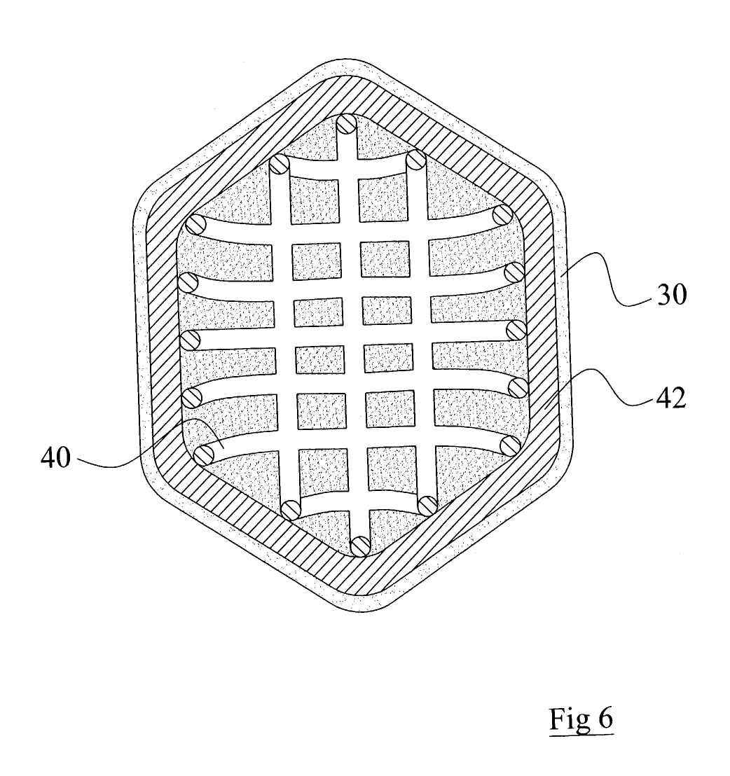

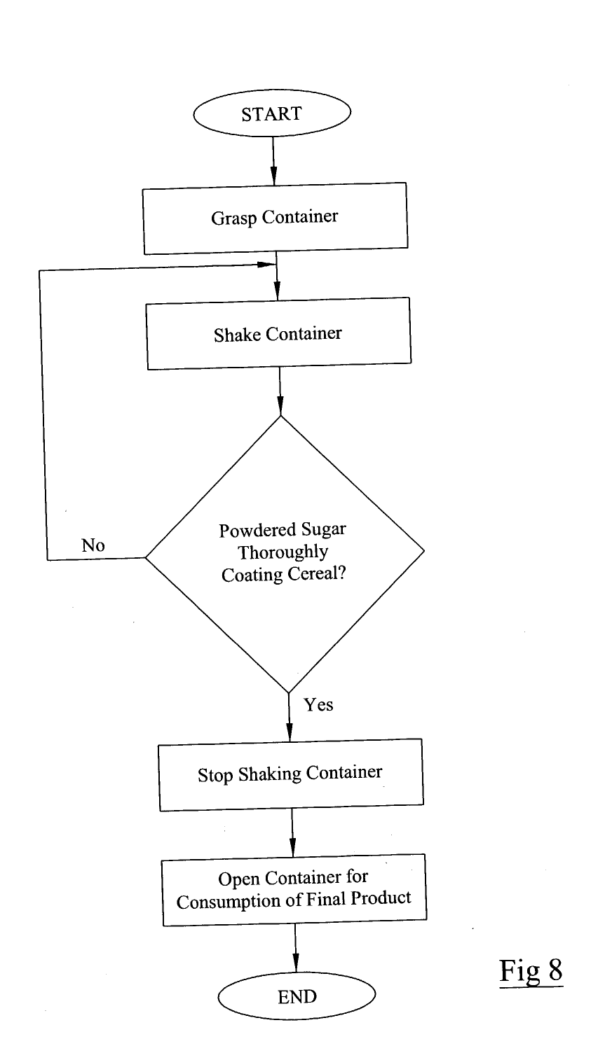

FIG. 8 illustrates the operation by the end consumer with the present invention to create the end product. Once the consumer receives the packaged unit and desires to consume the contents, the consumer first grasps the container 20 for manual manipulation. The consumer preferably shakes and manipulates the container 20 thereby causing the cereal members 40 and the sweetener 30 to pass about within the interior of the sealed container 20 as shown in FIG. 2 of the drawings. As the cereal members 40 and the sweetener 30 are manipulated within the container 20, the sweetener 30 begins to attached to and coat the outer coating 42 of the cereal member 40 as best illustrated in FIG. 6 of the drawings.

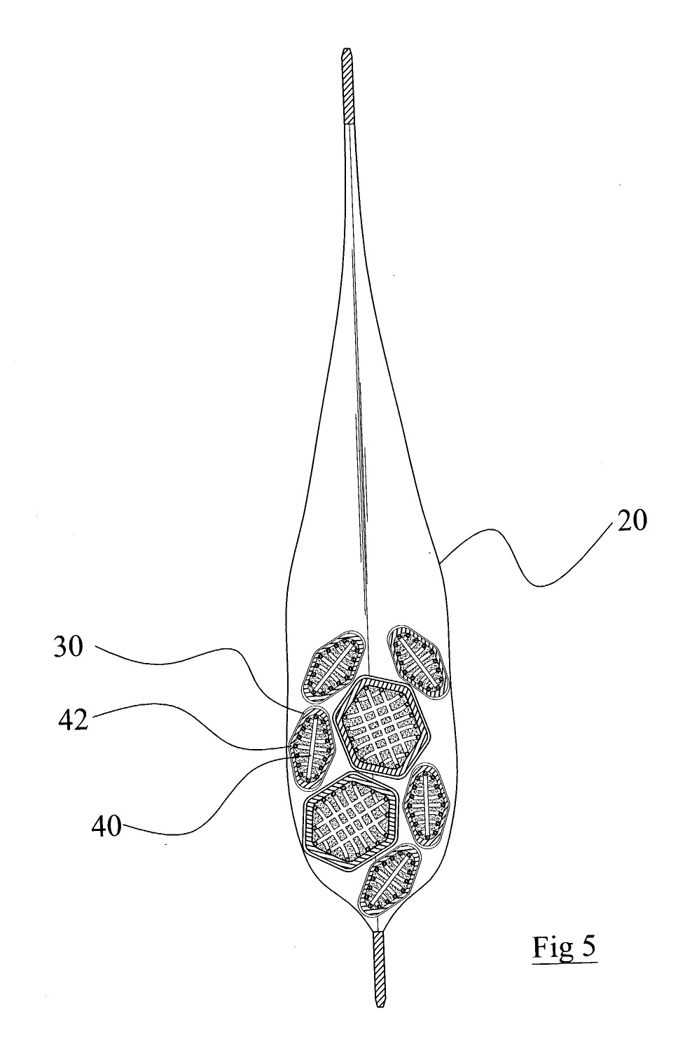

After all or a desired portion of the cereal members 40 have been thoroughly coated with the desired amount of sweetener 30 forming the end product, the consumer then terminates shaking of the container 20. The cereal members 40 then have the outer coating 42 along with a coating of the sweetener 30 as shown in FIGS. 5 and 6 of the drawings. The consumer then opens the container 20 and then is able to access and consume the end product. If the consumer finds that the cereal members 40 require additional coating with the sweetener 30, the consumer may simply reseal the container 20 and repeat the above-stated process again as desired.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A food product system, comprising:
a container;
a volume of sweetener positioned within an interior lower portion of said container; and
a volume of cereal members positioned upon said volume of sweetener within said container.

2. The food product system of claim 1, wherein said container is sealed.

3. The food product system of claim 1, including an outer coating surrounding each of said cereal members.

4. The food product system of claim 3, wherein said outer coating is a chocolate based material.

5. The food product system of claim 4, wherein said outer coating is comprised of a combination of chocolate and peanut butter.

6. The food product system of claim 5, wherein said sweetener is comprised of a powdered sugar.

7. The food product system of claim 1, wherein said sweetener is comprised of a powdered sugar.

8. The food product system of claim 1, wherein said cereal members have a hollow structure.

9. The food product system of claim 1, wherein said container is a flexible bag structure.

10. The food product system of claim 9, wherein said container is translucent.

11. A method of manufacturing a food product, said method comprising:
positioning a volume of sweetener within an interior lower portion of a container;
positioning a volume of cereal members positioned upon said volume of sweetener within said container; and
sealing said container.

12. The method of manufacturing a food product of claim 11, wherein said container is translucent.

13. The method of manufacturing a food product of claim 11, including an outer coating surrounding each of said cereal members.

14. The method of manufacturing a food product of claim 13, wherein said outer coating is a chocolate based material.

15. The method of manufacturing a food product of claim 14, wherein said outer coating is comprised of a combination of chocolate and peanut butter.

16. The method of manufacturing a food product of claim 15, wherein said sweetener is comprised of a powdered sugar.

17. The method of manufacturing a food product of claim 11, wherein said sweetener is comprised of a powdered sugar.

18. The method of manufacturing a food product of claim 11, wherein said cereal members have a hollow structure.

19. The method of manufacturing a food product of claim 11, wherein said container is a flexible bag structure.

20. A method of operating a food product, said food product comprised of a container, a volume of sweetener positioned within an interior lower portion of said container, a volume of cereal members positioned upon said volume of sweetener within said container, and an outer coating surrounding said cereal members, said method comprising:
grasping said container;
manipulating said container in a shaking manner thereby causing said sweetener to mix and coat with said cereal members; and
terminating said manipulating after said cereal members are thoroughly coated with said sweetener.
